(19) United States
(12) Patent Application Publication
(10) Pub. No.: US 2011/0152061 A1
(43) Pub. Date: Jun. 23, 2011

(54) PHOTOSENSITIVE PASTE COMPOSITION FOR FORMING BARRIER RIBS OF PLASMA DISPLAY PANEL

(75) Inventors: Beom-Wook Lee, Yongin-si (KR); Jong-Seo Choi, Yongin-si (KR)

(73) Assignee: SAMSUNG SDI., LTD., Yongin-si (KR)

(21) Appl. No.: 12/959,099

(22) Filed: Dec. 2, 2010

(30) Foreign Application Priority Data
Dec. 23, 2009 (KR) 10-2009-0130027

(51) Int. Cl. C04B 35/14; C08L 33/02

(52) U.S. Cl. 501/154; 522/39

(57) ABSTRACT

A photosensitive paste composition for forming barrier ribs of a plasma display panel (PDP). The photosensitive paste composition includes an inorganic material including SiO₂ and at least one of B₂O₃ and P₂O₅, and an organic material containing photosensitive components, wherein the total content of SiO₂ and B₂O₃ is about 50 wt % to about 80 wt % with respect to 100 wt % of the inorganic material, or a content of SiO2 and P2O5 is about 50 wt % to about 80 wt % with respect to 100 wt % of the inorganic material.

### CLAIM OF PRIORITY

This application makes reference to, incorporates the same herein, and claims all benefits accruing under 35 U.S.C. §119 from an application earlier filed in the Korean Intellectual Property Office on the 23 of Dec. 2009 and there duly assigned Serial No. 10-2009-0130027.

### BACKGROUND OF THE INVENTION

1. Field of the Invention

The present invention relates to a photosensitive paste composition for forming barrier ribs of a plasma display panel (PDP).

2. Description of the Related Art

In a plasma display panel (PDP), barrier ribs are formed on a lower plate (or on a rear substrate) and are used to ensure discharge spaces and to prevent electrical and optical cross talk between neighboring cells. Barrier ribs may have various shapes (e.g., stripes or a matrix) and measurements (e.g., a width and a pitch) according to the type of PDP.

Barrier ribs are formed by sequentially forming address electrodes and dielectrics on a lower plate of a PDP and then performing a sand blast method, an etching method or a photolithography method.

In the sand blast method, a barrier rib paste is printed once by using, for example, a table coater, and then is dried so as to form a film having a desired thickness, a dry film resist having sand resistance is laminated and is patterned by performing exposing and developing processes. After that, a fine abrasive is sprayed at high pressure in a sanding process by using the pattern of the dry film resist as a mask so as to pattern barrier ribs, the remaining dry film resist is removed, and then a baking process is performed, thereby completely forming the barrier ribs.

The etching method is similar to the sand blast method. In an etching method, a baked film is patterned by using an etchant instead of a sanding process so as to form barrier ribs.

In the photolithography method, a photosensitive paste is printed and dried so as to form a film, the film is exposed to light by using a ultraviolet exposure device having a photomask, the printing, drying and exposing processes are repeatedly performed so as to achieve a desired thickness of the film, unexposed parts are selectively removed in a developing process, and then a baking process is performed, thereby forming barrier ribs.

### SUMMARY OF THE INVENTION

The present invention includes a photosensitive paste composition for forming barrier ribs of a plasma display panel (PDP), which is environmentally friendly and has low power consumption.

The present invention includes barrier ribs of a PDP, which are formed using the photosensitive paste composition.

The present invention includes a PDP including the barrier ribs.

Additional aspects will be set forth in part in the description which follows and, in part, will be apparent from the description, or may be learned by practice of the presented embodiments.

According to an embodiment of the present invention, a photosensitive paste composition for forming barrier ribs of a plasma display panel (PDP) includes an inorganic material; and an organic material containing photosensitive components, wherein the inorganic material comprises SiO₂, the inorganic material further comprises B₂O₃ or P₂O₅, or both, and wherein a content of SiO₂ and B₂O₃ is about 50 wt % to about 80 wt % with respect to 100 wt % of the inorganic material, or a content of SiO₂ and P₂O₅ is about 50 wt % to about 80 wt % with respect to 100 wt % of the inorganic material.

A content of SiO₂ and B₂O₃ may be about 55 wt % to about 60 wt % with respect to 100 wt % of the inorganic material.

A content of SiO₂ and P₂O₅ may be about 65 wt % to about 77 wt % with respect to 100 wt % of the inorganic material.

According to one or more embodiments of the present invention, barrier ribs of a plasma display panel (PDP) include an inorganic material, wherein the inorganic material includes SiO₂ and at least one of B₂O₃ and P₂O₅, and wherein a content of SiO₂ and B₂O₃ is about 50 wt % to about 80 wt % with respect to 100 wt % of the inorganic material, or a content of SiO₂ and P₂O₅ is about 50 wt % to about 80 wt % with respect to 100 wt % of the inorganic material.

A content of SiO₂ and B₂O₃ may be about 55 wt % to about 60 wt % with respect to 100 wt % of the inorganic material.

A content of SiO₂ and P₂O₅ may be about 65 wt % to about 77 wt % with respect to 100 wt % of the inorganic material.

A dielectric constant of the barrier ribs may be about 7 to about 8.

A refractive index of the barrier ribs may be about 1.50 to about 1.55.

According to one or more embodiments of the present invention, a plasma display panel (PDP) includes the above-described barrier ribs.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a partial perspective view of a plasma display panel (PDP), according to an embodiment of the present invention.

FIG. 2 is a flowchart showing the preparation of a photosensitive paste composition according to an embodiment of the invention.

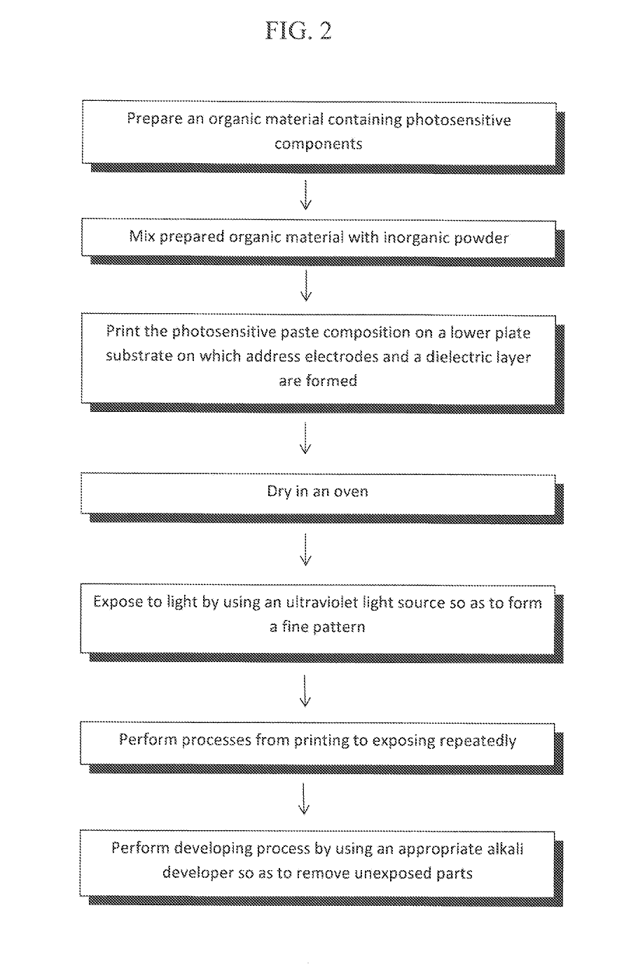

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

First, an inorganic material suggested according to the related art contains PbO or Bi₂O₃ that is an environmentally harmful material. Second, since the dielectric constant of the inorganic material containing PbO or Bi₂O₃ is greater than that of a PbO-free or Bi₂O₃-free inorganic material, the driving efficiency of a plasma display panel (PDP) is reduced and thus power consumption is increased.

A photosensitive paste composition for forming barrier ribs of a PDP, according to an embodiment of the present invention, includes an inorganic material and an organic material containing photosensitive components. The inorganic material of the photosensitive paste composition may contain SiO₂ and at least one of B₂O₃ and P₂O₅, and the content of SiO₂ and B₂O₃ may be about 50 wt % to about 80 wt % with respect to 100 wt % of the inorganic material, or a content of SiO₂ and P₂O₅ may be about 50 wt % to about 80 wt % with respect to 100 wt % of the inorganic material. If barrier ribs of a PDP are formed by using the above-described photosensitive paste composition, the PDP may have a high driving efficiency and have a high value of brightness versus a driving voltage. Accordingly, the photosensitive paste composition may be advantageously used.

The inorganic material is environmentally friendly and has a low dielectric constant and thus the driving efficiency of a PDP may be increased and power consumption may be reduced.

The inorganic material is formed of glass frit and a filler. Although not limited thereto, the glass frit may be formed of a complex oxide containing three or more selected from the group consisting of oxides of silicon (Si), boron (B), aluminium (Al), barium (Ba), zinc (Zn), magnesium (Mg), calcium (Ca), lithium (Li), sodium (Na), potassium (K) and phosphorus (P). One complex oxide may be used solely or two complex oxides may be mixed and used together.

In particular, the glass frit may be formed of one selected from the group consisting of an SiO₂—B₂O₃—Al₂O₃-based material, an SiO₂—B₂O₃—BaO-based material, an SiO₂—B₂O₃—CaO-based material, an SiO₂—B₂O₃—ZnO-based material, a P₂O₅—BaO-based material and a P₂O₅—ZnO-based material. Also, one of the above materials may be used solely or two of the above materials may be mixed and used together.

Although not limited particularly, the shape of particles of the glass frit may be spherical because the more spherical the particles are, the more excellent their filling factor and ultraviolet transmittance are.

With respect to the size of the glass frit particles, an intermediate value (D₅₀) may be about 2 μm to about 5 μm, a minimum value (Dₘᵢₙ) may be equal to or greater than about 0.1 μm, and a maximum value (Dₘₐₓ) may be equal to or less than about 20 μm, so as to obtain a desired shape of the barrier ribs in consideration of a printing property and contraction in a baking process.

A softening temperature (Tₛ) of the glass frit may satisfy Inequality (1) such that the shape of the barrier ribs is maintained in the baking process and sintering is appropriately performed.

(Baking Temperature−80° C.)<Tₛ<Baking Temperature (1)

The content of the glass frit may be about 75 wt % to about 95 wt % with respect to the inorganic material. If the content of the glass frit is within the above-mentioned range, roughness in surfaces of the barrier ribs and the density in the barrier ribs may be appropriate, and a desired shape of the barrier ribs may be obtained after the baking process.

Although not limited thereto, the filler of the inorganic material may be formed of a complex oxide containing two or more selected from the group consisting of oxides of Si, B, Al, Ba, Zn, Mg and Ca. One complex oxide may be used solely or two complex oxides may be mixed and used together.

In particular, the filler may be formed of one selected from the group consisting of SiO₂, an SiO₂—B₂O₃-based material and an SiO₂—Al₂O₃-based material.

Although not limited particularly, the shape of particles of the filler may be spherical because the more spherical the particles are, the more excellent their filling factor and ultraviolet transmittance are.

With respect to the size of the filler particles, an intermediate value may be about 1 μm to about 4 μm, a minimum value may be equal to or greater than about 0.1 μm, and a maximum value may be equal to or less than about 20 μm. If the size of the filler particles is within the above-mentioned range, an exposure sensitivity may be appropriately maintained and a desired shape of the barrier ribs may be obtained with respect to the density and the linearity of the barrier ribs in consideration of contraction in the baking process.

A softening temperature of the filler may satisfy Inequality (2) such that the shape of the barrier ribs is maintained in the baking process.

Tₛ>(Baking Temperature+20° C.) (2)

The content of the filler may be about 5 wt % to about 25 wt % with respect to the inorganic material because a desired shape of the barrier ribs may be obtained by preventing a pattern after the baking process from being deformed and desired physical properties of the barrier ribs in roughness and internal density may be obtained.

The inorganic material may contain SiO₂ and at least one of B₂O₃ and P₂O₅. That is, it the inorganic material may contain SiO₂ and B₂O₃, SiO₂ and P₂O₅, or all of SiO₂, B₂O₃ and P₂O₅. If the inorganic material contains all of SiO₂, B₂O₃ and P₂O₅, the content of SiO₂ and the content of one of B₂O₃ and P₂O₅, which is contained more than the other, are summed.

In the inorganic material, the content of SiO₂ and B₂O₃ may be about 50 wt % to about 80 wt % with respect to 100 wt % of the inorganic material, or a content of SiO₂ and P₂O₅ is about 50 wt % to about 80 wt % with respect to 100 wt % of the inorganic material. In particular, the content of SiO₂ and B₂O₃ may be about 55 wt % to about 60 wt % with respect to 100 wt % of the inorganic material and the content of SiO₂ and P₂O₅ may be about 65 wt % to about 77 wt % with respect to 100 wt % of the inorganic material. If the content of the inorganic material is within the above-mentioned range, the difference in refractive index between the organic and inorganic materials may not be large, a thermal property may be excellent, a desired shape of the barrier ribs may be obtained, and the driving efficiency of the PDP may be increased.

The thermal expansion coefficient of the inorganic material formed of the glass frit and the filler may be close to the thermal expansion coefficient of a substrate on which the barrier ribs are formed. If the difference in thermal expansion coefficient between the glass frit and the substrate is large, the substrate may be bent or may be broken in a worse case scenario.

The dielectric constant of the barrier ribs formed of the photosensitive paste composition may be about 7 to about 8 and the refractive index of the barrier ribs may be about 1.50 to about 1.55.

In the photosensitive paste composition, if the content of SiO₂ and B₂O₃, or SiO₂ and to P₂O₅ is about 50 wt % to about 80 wt % with respect to 100 wt % of the inorganic material, the dielectric constant and the refractive index of the barrier ribs are within the above-mentioned ranges. If the dielectric constant and the refractive index are within the above-mentioned ranges, the driving efficiency of the PDP may be highly increased.

The content of the inorganic material may be about 50 wt % to about 80 wt % with respect to the photosensitive paste composition. If the content of the inorganic material is within the above-mentioned range, the PDP may have a high driving efficiency and have a high value of brightness versus a driving voltage.

The photosensitive paste composition also may contain an organic material containing photosensitive components. The content of the organic material may be about 20 wt % to about 50 wt % with respect to the photosensitive paste composition so as to obtain a paste material having desired physical properties and to appropriately use the paste material.

The photosensitive paste composition is formed in the barrier ribs by performing drying and baking processes and thus components of the organic material of the photosensitive paste composition are removed during the drying and baking processes. Accordingly, the content of SiO₂ and B₂O₃, or SiO₂ and P₂O₅ in the barrier ribs is equal to that with respect to 100 wt % of the inorganic material in the photosensitive paste composition.

That is, the total content of SiO₂ and one of B₂O₃ and P₂O₅, which is contained more than the other, in the barrier ribs may be about 50 wt % to about 80 wt % with respect to 100 wt % of the inorganic material. In particular, for example, the content of SiO₂ and B₂O₃ in the barrier ribs may be about 55 wt % to about 60 wt % or the content of SiO₂ and P₂O₅ in the barrier ribs may be about 65 wt % to about 77 wt %.

The photosensitive components of the organic material include an organic binder, a crosslinking agent, a photoinitiator, a solvent and other additives.

If an alkali aqueous solution is used as a developer in a developing process, the organic binder may contain an acid group. The organic binder may be one of various polymers. From among the polymers, acrylic resin is most appropriate in terms of price and properties. In order to contain an acid group in an acrylic resin, a monomer containing a carboxyl group may be used. Accordingly, the organic binder may be a copolymer of a monomer containing a carboxyl group and one or more other monomers.

Although not limited hereto, the monomer containing a carboxyl group may be at least one selected from the group consisting of acrylic acid, methacrylic acid, fumaric acid, maleic acid, vinyl acetic acid and anhydrides thereof. Another monomer to be copolymerized with the monomer containing a carboxyl group may be a compound containing an acryl group.

Also, a component for causing a crosslinking reaction in the organic binder by reacting the carboxyl group of the copolymer (of a monomer containing a carboxyl group and one or more other monomers) with an ethylenically unsaturated compound may be added to the organic binder.

The ethylenically unsaturated compound may be one selected from the group consisting of glycidyl methacrylate, 3,4-epoxy cyclohexyl methyl methacrylate and 3,4-epoxy cyclohexyl methyl acrylate.

Furthermore, as the organic binder, the copolymer may be solely used or a cellulose-based compound may be used for film levelling or thixotropic property improvement.

The molecular weight of the copolymer may be about 5,000 g/mol to about 100,000 g/mol so as to obtain an excellent printability of a paste and to appropriately remove unexposed parts in a developing process. Also, the acid value of the copolymer may be about 50 mgKOH/g to about 200 mgKOH/g so as to ensure the developability of a paste.

The content of the organic binder is determined according to the content of the inorganic material, whether a thickener is added, the content of the thickener and the like, and may be about 10 wt % to about 50 wt % with respect to the organic material in consideration of the viscosity and printability of a paste, and the developability and contraction after a printing process.

The crosslinking agent may be a monofunctional or multifunctional monomer. In general, a multifunctional monomer having an excellent exposure sensitivity is used.

Although not limited thereto, the multifunctional monomer may be an acrylate-based compound.

If the content of the crosslinking agent is excessively small, an exposure sensitivity may be reduced such that the barrier ribs may not be patterned appropriately. If the content of the crosslinking agent is excessively large, contraction may seriously occur such that a desired shape of the barrier ribs may not be obtained. Accordingly, the content of the crosslinking agent may be determined in consideration of the above factors and may be, for example, about 50 wt % to about 200 wt % with respect to the copolymer binder.

Although not limited thereto, the photoinitiator may be at least one selected from the group consisting of benzophenone, methyl o-benzoyl benzoate, 4,4-bis(dimethylamino)benzophenone, 4,4-bis(diethylamino)benzophenone, 2,2-diethoxyacetophenone, 2,2-dimethoxy-2-phenyl-2-phenylacetophenone, 2-methyl-2-morpholinopropane-1-on, 2-benzyl-2-dimethylamino-1-(4-morpholinophenyl)-1-butanone, bis(2,6-dimethoxybenzoyl)-2,4,4-trimethyl pentyl phosphine oxide and bis(2,4,6-trimethylbenzoyl)pentyl phosphine oxide.

If the content of the photoinitiator is excessively small, the exposure sensitivity of a paste may be reduced such that a desired line width of the barrier ribs may not be obtained. If the content of the photoinitiator is excessively large, the line width of the barrier ribs may be excessively large or developing may be disabled. Accordingly, the content of the photoinitiator may be determined in consideration of the above factors and may be, for example, about 1 wt % to about 20 wt % with respect to the crosslinking agent.

The solvent is not limited to any particular solvent as long as the solvent may dissolve the organic binder and the photoinitiator, and may be mixed well with the crosslinking agent and the other additives. The solvent may have a boiling point equal to or higher than about 150° C. in consideration of a fact that the solvent is volatilized in a preparation process of the photosensitive paste composition, and more particularly, in a 3-roll mill process composition, or after the printing process.

Although not limited thereto, the solvent may be at least one selected from the group consisting of ethyl carbitol, butyl carbitol, ethyl carbitol acetate, butyl carbitol acetate, texanol, turpentine, dipropylene glycol methyl ether, dipropylene glycol ethyl ether, dipropylene glycol monomethyl ether acetate, γ-butyrolactone, cellosolve acetate, butyl cellosolve acetate and tripropylene glycol. Although not limited particularly, the content of the solvent may allow a paste to have an appropriate viscosity for printing or coating.

Also, the organic material may further contain the other additives such as a sensitizer for improving sensitivity, an inhibitor and an antioxidant for improving the preservability of the photosensitive paste composition, an ultraviolet absorbent for improving a resolution, defoamer for reducing forms in the photosensitive paste composition, a dispersant for improving dispersibility, a levelling agent for levelling a film in a printing process, and a plasticizer for providing a thixotropic property.

The photosensitive paste composition may be prepared by using the following method.

Initially, an organic material containing photosensitive components is prepared. As described above, the organic material may contain an organic binder, a photoinitiator, a crosslinking agent and additives, and may further contain a solvent if necessary. The organic material is prepared as a uniform and transparent solution by mixing predetermined amounts of the photosensitive components and sufficiently agitating them.

The prepared organic material is mixed with inorganic powder by using a planetary mixer (PLM), is mechanically mixed by performing a 3-roll mill process several times, is filtered by using SUS #400 through #600 meshes, and then is degassed by using a vacuum pump, thereby preparing the photosensitive paste composition.

According to another embodiment of the present invention, barrier ribs of a PDP are formed of the above-described photosensitive paste composition. The barrier ribs may be formed by performing a fine pattern forming process and a baking process.

In the fine pattern forming process, the photosensitive paste composition prepared as described above is printed on a lower plate substrate on which address electrodes and a dielectric layer are formed, is dried in a dry oven or an infrared (IR) oven at about 100° C. to about 150° C. for about 5 minutes to about 30 minutes so as to form a paste coating film, the paste coating film is exposed to light of about 300 nm to about 450 nm by using an ultraviolet light source so as to form a fine pattern, processes from printing to exposing are repeatedly performed, and then a developing process is performed by using an appropriate alkali developer such as a Na₂CO₃ solution, potassium hydroxide (KOH) or tetramethylammonium hydroxide (TMAH) at about 30° C. so as to remove unexposed parts. Also, in the baking process, the fine pattern formed as described above is baked at a peak temperature from about 540° C. to about 600° C. for about 10 minutes to about 30 minutes

According to another embodiment of the present invention, a PDP includes the above-described barrier ribs.

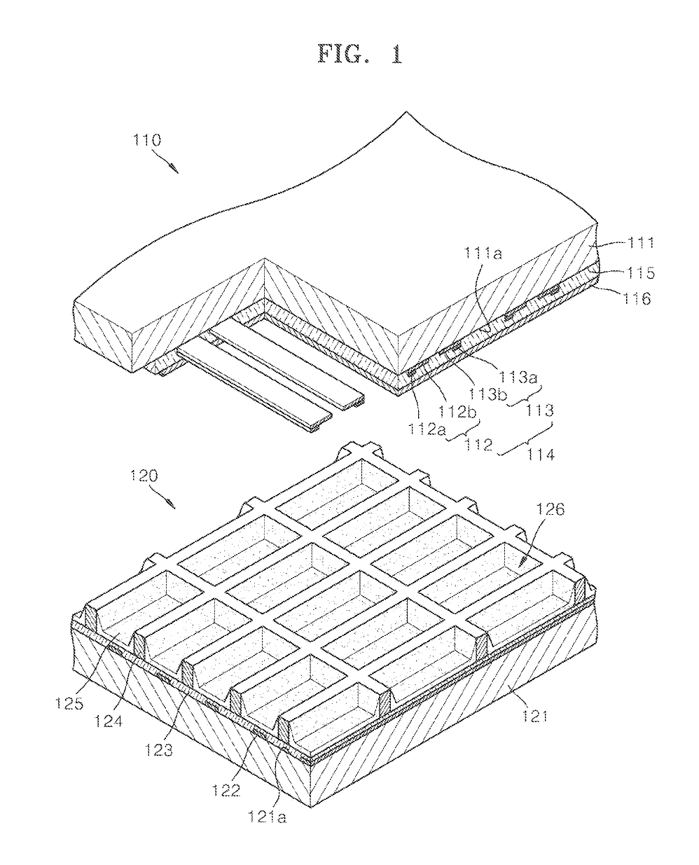

FIG. 1 is a partial perspective view of a PDP, according to an embodiment of the present invention.

Referring to FIG. 1, the PDP includes a front panel 110 and a rear panel 120. The front panel 110 includes a front substrate 111, sustain electrode pairs 114 including Y and X electrodes 112 and 113 formed on a rear surface 111a of the front substrate 111, a front dielectric layer 115 covering the sustain electrode pairs 114, and a protection layer 116 covering the front dielectric layer 115. The Y and X electrodes 112 and 113 respectively include transparent electrodes 112b and 113b formed of, for example, ITO, and bus electrodes 112a and 113a including black electrodes (not shown) for improving contrast and white electrodes (not shown) for providing conductivity. The bus electrodes 112a and 113a are connected to connection cables at left and right sides of the PDP.

The rear panel 120 includes a rear substrate 121, address electrodes 122 formed on a front surface 121a of the rear substrate 121 so as to cross the sustain electrode pairs 114, a rear dielectric layer 123 covering the address electrodes 122, barrier ribs 124 formed on the rear dielectric layer 123 so as to define light emission cells 126, and a phosphor layer 125 formed in the light emission cells 126. The address electrodes 122 are connected to connection cables at top and bottom sides of the PDP.

Examples of the present invention will now be described in detail. However, the scope of the present invention is not limited to these examples.

### EXAMPLES

### Example 1

50 wt % of glass frit A of Table 1, 10 wt % of a filler A of Table 2, and 40 wt % of an organic material of Table 3 were primarily mixed in a PLM, were secondarily mixed by using a 3-roll mill, were filtered by using SUS 306 #400 meshes, and then were vacuum degassed, thereby preparing a photosensitive paste composition.

The photosensitive paste composition was coated on a 6″ glass substrate, on which address electrodes and lower dielectrics were formed, by using a coater, to have a wet thickness of 250 μm, and then dried in a dry oven at 130° C. for 15 minutes. After that, light of 150 mJ/μm was projected on the glass substrate by using a high-pressure mercury lamp ultraviolet exposure device having a matrix-pattern photomask (line width=30 μm, pitch=160 μm). The glass substrate was developed by spraying a 0.4% sodium carbonate aqueous solution of 30° C. at a nozzle pressure of 1.5 kgf/cm² for 300 sec., and then was cleaned by spraying pure water of room temperature at a nozzle pressure of 1.0 kgf/cm² for 30 sec. After that, the glass substrate was dried by using an air knife and then was baked in an electric furnace at a peak temperature of 570° C. for 20 minutes, thereby forming barrier ribs.

R, G, B phosphors were printed on the glass substrate, on which the barrier ribs were formed, by using a screen printer and then were dried, thereby forming a lower plate on which a phosphor layer was formed.

After that, by using a sealant, the lower plate was adhered to an upper plate in which bus electrodes, upper dielectrics and an MgO film were formed on a glass substrate, the adhered upper and lower plates were baked in a furnace at a peak temperature of 560° C. for 20 minutes so as to form a panel, and then an aging process was performed in order to perform a lighting test, thereby ultimately forming a test panel 1.

A lighting test result of the test panel 1 is shown in Table 4.

The dielectric constant and the refractive index of the barrier ribs were respectively measured as 7.25 and 1.53.

### Example 2

50 wt % of glass frit B of Table 1, 10 wt % of a filler B of Table 2, and 40 wt % of an organic material of Table 3 were primarily mixed in a PLM, were secondarily mixed by using a 3-roll mill, were filtered by using SUS #400 meshes, and then were vacuum degassed, thereby preparing a photosensitive paste composition. After that, a test panel 2 was formed by performing the same processes performed in Example 1. A lighting test result of the test panel 2 is shown in Table 4.

The dielectric constant and the refractive index of barrier ribs were respectively measured as 7.65 and 1.53.

### Example 3

50 wt % of glass frit B of Table 1, 10 wt % of a filler A of Table 2, and 40 wt % of an organic material of Table 3 were primarily mixed in a PLM, were secondarily mixed by using a 3-roll mill, were filtered by using SUS #400 meshes, and then were vacuum degassed, thereby preparing a photosensitive paste composition. After that, a test panel 3 was formed by performing the same processes performed in Example 1. A lighting test result of the test panel 3 is shown in Table 4.

The dielectric constant and the refractive index of barrier ribs were respectively measured as 7.08 and 1.52.

### Comparative Example 1

50 wt % of glass frit A of Table 1, 10 wt % of a filler C of Table 2, and 40 wt % of an organic material of Table 3 were primarily mixed in a PLM, were secondarily mixed by using a 3-roll mill, were filtered by using SUS #400 meshes, and then were vacuum degassed, thereby preparing a photosensitive paste composition. After that, a test panel 4 was formed by performing the same processes performed in Example 1. A lighting test result of the test panel 4 is shown in Table 4.

The dielectric constant and the refractive index of barrier ribs were respectively measured as 8.20 and 1.58.

### Comparative Example 2

50 wt % of glass frit C of Table 1, 10 wt % of a filler A of Table 2, and 40 wt % of an organic material of Table 3 were primarily mixed in a PLM, were secondarily mixed by using a 3-roll mill, were filtered by using SUS #400 meshes, and then were vacuum degassed, thereby preparing a photosensitive paste composition. After that, a test panel 5 was formed by performing the same processes performed in Example 1. A lighting test result of the test panel 5 is shown in Table 4.

The dielectric constant and the refractive index of barrier ribs were respectively measured as 10.3 and 1.65.

TABLE 1
Glass Frit Composition (unit: wt %)

| Component | Glass Frit A | Glass Frit B | Glass Frit C |
|---|---|---|---|
| SiO₂ | 10 | 5 | 13 |
| B₂O₃ | 40 | — | 18 |
| Al₂O₃ | 19 | 3 | 4 |
| BaO | — | 8 | 14 |
| ZnO | 16 | 18 | 21 |
| MgO | 3 | | 4 |
| CaO | 4 | | |
| Li₂O | 2 | | — |
| Na₂O | 6 | | — |
| Bi₂O₃ | — | | 26 |
| P₂O₅ | — | 66 | — |

TABLE 2
Filler Composition (unit: wt %)

| Component | Filler A | Filler B | Filler C |
|---|---|---|---|
| SiO₂ | 100 | 50 | — |
| B₂O₃ | — | 12 | — |
| Al₂O₃ | — | 30 | 100 |
| BaO | — | 5 | — |
| ZnO | — | 5 | — |
| Na₂O | — | 5 | — |

TABLE 3
Organic Material Composition (unit: wt %)

| Composition | Component | Content |
|---|---|---|
| Binder 1 | acryl polymer having carboxyl group, molecular weight | 32.5 |
| | 12,000 g/mol, acid value 150 mgKOH/g | |
| Binder 2 | hydroxypropyl cellulose | 0.5 |
| Crosslinking Agent 1 | trimethylolpropane triacrylate | 16.4 |
| Crosslinking Agent 2 | pentaerythritol hexaacrylate | 4.8 |
| Initiator | 2-benzyl-2-dimethylamino-1-(4-morpholinophenyl)-1- | 2.5 |
| | butanone | |
| Dispersant | BYK 110 (BirdChem Co., Ltd.) | 1.5 |
| Levelling Agent | BYK 306 (BirdChem Co., Ltd.) | 0.2 |
| Solvent | gamma-butyrolactone | 41.6 |

TABLE 4
Lighting Test Result

| | Exam- | Exam- | Exam- | Comparative | Comparative |
|---|---|---|---|---|---|
| Component | ple 1 | ple 2 | ple 3 | Example 1 | Example 2 |
| B/P | 1.21 | 1.24 | 1.32 | 0.98 | 1.03 |

(B/P: Brightness/Power, a value of brightness versus a driving voltage)

Table 5 shows the content of SiO₂ and B₂O₃, or SiO₂ and P₂O₅ in wt % with respect to an inorganic material in Examples 1 to 3, and Comparative Examples 1 and 2.

TABLE 5
Content of SiO₂ and B₂O₃, or SiO₂
and P₂O₅ in Inorganic Material (unit: wt %)

| | Exam- | Exam- | Exam- | Comparative | Comparative |
|---|---|---|---|---|---|
| Component | ple 1 | ple 2 | ple 3 | Example 1 | Example 2 |
| SiO₂ + | 58.3 | | | 41.6 | 42.5 |
| B₂O₃ | | | | | |
| SiO₂ + | | 67.5 | 75.8 | | |
| P₂O₅ | | | | | |

As shown in Tables 4 and 5, in Examples 1 to 3 in which the content of SiO₂ and B₂O₃, or SiO₂ and P₂O₅ was greater than 50 wt %, B/P values were high and were greater than 1.2. On the other hand, in Comparative Examples 1 and 2 in which the content of SiO₂ and B₂O₃, or SiO₂ and P₂O₅ was less than 50 wt %, B/P values were relatively low.

The results show that the inorganic material used in Examples 1 to 3 had a high driving efficiency due to a relatively low dielectric constant in comparison to the inorganic material used in Comparative Examples 1 and 2, and thus had a high B/P value.

As described above, according to one or more of the above embodiments of the present invention, a photosensitive paste composition appropriate for forming photosensitive barrier ribs may have environmentally friendly properties and may improve the driving efficiency of a PDP so as to reduce power consumption.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A photosensitive paste composition for forming barrier ribs of a plasma display panel (PDP), the photosensitive paste composition comprising:
an inorganic material; and
an organic material containing photosensitive components;
the inorganic material comprises SiO₂;
the inorganic material further comprises B₂O₃ or P₂O₅, or both; and
a content of SiO₂ and B₂O₃ is about 50 wt % to about 80 wt % with respect to 100 wt % of the inorganic material, or a content of SiO₂ and P₂O₅ is about 50 wt % to about 80 wt % with respect to 100 wt % of the inorganic material.

2. The photosensitive paste composition of claim 1, the composition comprising B₂O₃ and wherein the content of SiO₂ and B₂O₃ is about 55 wt % to about 60 wt % with respect to 100 wt % of the inorganic material.

3. The photosensitive paste composition of claim 1, the composition comprising P₂O₅ and wherein the content of SiO₂ and P₂O₅ is about 65 wt % to about 77 wt % with respect to 100 wt % of the inorganic material.

4. Barrier ribs of a plasma display panel (PDP), the barrier ribs comprising an inorganic material:
wherein the inorganic material comprises SiO₂;
the inorganic material further comprises B₂O₃ or P₂O₅, or both; and
wherein a content of SiO₂ and B₂O₃ is about 50 wt % to about 80 wt % with respect to 100 wt % of the inorganic material, or a content of SiO₂ and P₂O₅ is about 50 wt % to about 80 wt % with respect to 100 wt % of the inorganic material.

5. The barrier ribs of claim 4, the barrier ribs comprising B₂O₃ and wherein the content of SiO₂ and B₂O₃ is about 55 wt % to about 60 wt % with respect to 100 wt % of the inorganic material.

6. The barrier ribs of claim 4, the barrier ribs comprising P₂O₅ and wherein the content of SiO₂ and P₂O₅ is about 65 wt % to about 77 wt % with respect to 100 wt % of the inorganic material.

7. The barrier ribs of claim 4, wherein a dielectric constant of the barrier ribs is about 7 to about 8.

8. The barrier ribs of claim 4, wherein a refractive index of the barrier ribs is about 1.50 to about 1.55.

9. A plasma display panel (PDP) comprising barrier ribs of claim 4.
